(19) United States
(12) Patent Application Publication
(10) Pub. No.: US 2026/0201925 A1
(43) Pub. Date: Jul. 16, 2026

(54) LOW-NOISE SWIVEL CHAIR

(71) Applicant: YUJIANG LIN, Cixi (CN)

(72) Inventor: YUJIANG LIN, Cixi (CN)

(21) Appl. No.: 19/445,761

(22) Filed: Jan. 12, 2026

(30) Foreign Application Priority Data
Jan. 13, 2025 (CN) 202520068412.2
Jan. 7, 2026 (CN) 202610013125.0

(51) Int. Cl. F16C 19/06; A47C 3/18; A47C 7/00

(52) U.S. Cl. CPC F16C 19/06; A47C 3/18; A47C 7/004; F16C 2314/73

(57) ABSTRACT

A low-noise swivel chair is provided, which includes a seat rotation unit, and the seat rotation unit includes a fixing base for connecting with a support base and a fixing column for connecting with a seat. The fixing column is rotatably connected to the fixing base through a rotating component. The rotating component includes a first rotating part provided between an inner wall of the fixing base and an outer wall of the fixing column and configured to withstand a radial force of the fixing column; a second rotating part that is sleeved on an outer circumference of the fixing column. The fixing column is provided with a support portion that is radially outward extending and supported on the second rotating part. A lower end of the second rotating part is supported on the fixing base to withstand an axial force of the fixing column.

### CROSS-REFERENCE TO RELATED APPLICATIONS

This application claims priority to Chinese Patent Application No. 202520068412.2, filed on January 13, 2025, and Chinese Patent Application No. 202610013125.0, filed on January 07, 2026. Both of which are hereby incorporated by reference in their entireties.

### TECHNICAL FIELD

The present disclosure relates to the field of swivel chair technologies, and in particular, to a low-noise swivel chair.

### BACKGROUND

Chairs have become indispensable furniture in modern office and home environments, with one of their core functions being to allow a user to freely adjust direction through a rotation of the chairs. A swivel chair is mainly equipped with a fixing base and a fixing column at its rotation point, which are used to connect a seat of the swivel chair with a roller base. Simultaneously, the direction can be rotated and adjusted by fixing the column within the fixing base.

In ideal conditions or initial use, due to the small clearance between components and sufficient lubrication, the noise may not be significant. However, under the following specific conditions, noise issues may become prominent and even affect the user experience. For example, when the user has a large body weight, or changes his sitting posture or tilts his seat, the radial and axial pressure between the fixing column and the fixing base will significantly increase. Under such high loads, the friction between the two contact surfaces intensifies, resulting in frictional noise between metal and plastic (or metal to metal) components; after long-term and high-frequency use, the direct friction contact surface between the fixing column and the fixing base of the swivel chair will inevitably wear out, which will cause abnormal noise when the components are rotated.

### SUMMARY

To address the shortcomings of existing technology, a low-noise swivel chair is provided.

The present disclosure is implemented using the following technical solution: a low-noise swivel chair including: a seat rotation unit, and the seat rotation unit includes a fixing base configured to connect with a support base and a fixing column configured to connect with a seat, where the fixing column passes through the fixing base in an axial direction and is rotatably connected to the fixing base through a rotating component, where the rotating component includes: a first rotating part, which is provided between an inner wall of the fixing base and an outer wall of the fixing column and is configured to withstand a radial force of the fixing column; a second rotating part, which is sleeved on an outer circumference of the fixing column and provided above the fixing base; the fixing column is provided with a support portion that is radially outward extending, and the support portion is supported on the second rotating part, a lower end of the second rotating part is supported on the fixing base to withstand an axial force of the fixing column.

Through the above structural settings, a transmission path of the axial force (mainly derived from a user’s weight) is clearly defined: fixing column - support portion - second rotating part - fixing base. In this path, there is no direct contact between the fixing column and the fixing base in both axial and radial directions; the axial force is transmitted through the second rotating part, and the radial force is transmitted through the first rotating part. This force transmission mechanism ensures that the radial and axial pressure generated when the user has a large body weight or changes his sitting posture or leans on the seat can be effectively transmitted through dedicated components, thereby avoiding noise caused by direct friction from the source. At the same time, due to a complete isolation between the fixing column and the fixing base, the wear between the two is minimized, thereby allowing the swivel chair to maintain excellent low noise performance even after long-term use.

In some embodiments of the present disclosure, an outer side of the second rotating part is provided with a housing, an upper end of the housing is fixedly connected to the support portion, a chamber configured to accommodate the second rotating part is provided between the housing and the fixing column, and the housing is not in contact with the fixing base below; an annular gap is provided between a lower end of the housing and the fixing column, and an upper end of the first rotating part extends upward and extends into the chamber through the annular gap, thereby providing an axial support for the second rotating part.

A dedicated storage space is provided for the second rotating part by providing the housing. To avoid noise caused by direct contact and friction between the housing and the fixing base, this design extends the upper end of the first rotating part into the chamber and directly supports the second rotating part in an axial direction, thereby maintaining a non-contact state between the housing and the fixing base, thereby effectively avoiding the generation of noise here. At the same time, the axial force withstood by the second rotating part is also transmitted to the fixing base through the first rotating part, thereby completing the effective transmission of force.

In some embodiments of the present disclosure, an outer wall of the support portion is provided with a buckle groove that has an outward opening; the housing is provided with a corresponding buckle position; the housing is connected to the fixing column through a cooperation between the buckle groove and the buckle position.

In some embodiments of the present disclosure, the first rotating part includes: a plurality of rotation slots, which are uniformly spaced in a circular shape on the inner wall of the fixing base, radial inner sides of the rotation slots have openings, and the rotation slots axially and upward penetrate through a top of the fixing base; a rotation column, which is rotatably accommodated in the rotation slots, and a portion of the rotation column that is radially facing an axis protrudes from the openings; a first fixing ring, which is fixed at the top of the fixing base and configured for axial limiting the rotation column, and an upper end surface of the first fixing ring is in contact with the lower end of the second rotating part.

By a part of the rotation column that is protruded being contacted with the outer wall of the fixing column, when the fixing column is rotated, the rotation column rolls in its groove. This design transforms a traditional sliding friction into a rolling friction, thereby significantly reducing the noise generated during rotation and effectively reducing the wear of a contact surface.

In some embodiments of the present disclosure, the top of the fixing base is provided with a fixing groove with an upward opening, and a lower end of the first fixing ring is embedded in the fixing groove; the first fixing ring is provided with a fixing hole corresponding to a bottom wall of the fixing groove, and a fixing member is inserted into the fixing hole to fix the first fixing ring to the fixing base.

By providing the fixing groove as described above, the first fixing ring can be positioned. Where the fixing member can be a screw, a rivet, and so on.

In some embodiments of the present disclosure, the second rotating part includes an upper fixing ring, a lower fixing ring, and a bearing unit; the upper fixing ring, the lower fixing ring, and the bearing unit are sleeved on the outer circumference of the fixing column, and the bearing unit is provided between the upper fixing ring and the lower fixing ring; the support portion is supported on an upper surface of the upper fixing ring; the housing is sleeved on outer circumferences of the upper fixing ring, the lower fixing ring, and the bearing unit, the lower end of the housing has a circular support convex edge, and the circular support convex edge is supported on a lower surface of the lower fixing ring.

In some embodiments of the present disclosure, the circular support convex edge is not in contact with the fixing column, and the annular gap is formed between the circular support convex edge and the fixing column.

In some embodiments of the present disclosure, a revolving slot is provided at a position where the upper fixing ring and lower fixing ring that are abutted against the bearing unit.

By providing the revolving slot, the bearing unit achieves better rotational performance during rotation.

In some embodiments of the present disclosure, a bottom of the fixing column is provided with a buckle that is radially outward extending, and after the fixing column passing through the fixing base and completing assembly, the buckle is engaged with an edge of a lower end hole of the fixing base to axially limit the fixing column.

In some embodiments of the present disclosure, the fixing column is a hollow structure, and a connection column is provided inside, the connection column is fixedly connected to the fixing column; an upper end of the connection column is configured to fixedly connect with the seat; the support base includes a plurality of support feet, ends of the support feet are rotatably connected to the fixing base, and other ends are supported on ground; a connection ring that is configured to slide along an axial direction of the connection column is connected between each of the support feet through a connection rod; a lower end of the connection column passes through the connection ring and is rotatably connected to the connection ring.

By providing the connection column as described above, the connection ring is sleeved onto the connection column, allowing for axial limiting the connection ring. When the support feet are not in use and folded for storage, or when they need to be used and unfolded for support, the connection ring always adapts to sliding along the axial direction of the connection column. At the same time, the connection column and the connection ring are connected, and the connection ring does not affect a rotation of the connection column.

In some embodiments of the present disclosure, the connection ring and the connection column are rotatably connected through a third rotating part, and the third rotating part is a bearing component.

The use of the bearing component can reduce the noise generated by a friction between the connection column and the connection ring when the connection column is rotated with the fixing column.

Compared with the existing technology, the beneficial effect of the present disclosure is that through the above structural settings, the transmission path of the axial force (mainly derived from a user’s weight) is clearly defined: fixing column - support portion - second rotating part - fixing base. In this path, there is no direct contact between the fixing column and the fixing base in both axial and radial directions; the axial force is transmitted through the second rotating part, and the radial force is transmitted through the first rotating part. This force transmission mechanism ensures that the radial and axial pressure generated when the user has a large body weight or changes his sitting posture or leans on the seat can be effectively transmitted through dedicated components, thereby avoiding noise caused by direct friction from the source. At the same time, due to the complete isolation between the fixing column and the fixing base, the wear between the two is minimized, allowing the swivel chair to maintain excellent low noise performance even after long-term use. Besides that, the connection column rotatably connects to the connection ring through the bearding component, so that there is no noise when the connection column is rotated.

### BRIEF DESCRIPTION OF DRAWINGS

FIG. 1 is a schematic structural diagram of the present disclosure.

FIG. 2 is a schematic structural diagram of a seat rotation unit of the present disclosure.

FIG. 3 is a schematic diagram of an exploded structure of the seat rotation unit of the present disclosure.

FIG. 4 is a cross-sectional schematic diagram of the seat rotation unit of the present disclosure.

FIG. 5 is a schematic structural diagram of a third rotating part of the present disclosure.

FIG. 6 is a schematic diagram of the third rotating part which has the same structure as a first rotating part of the present disclosure.

FIG. 7 is an exploded view of FIG. 6.

Numeral reference: 1- seat rotation unit; 2- fixing base; 21- fixing groove; 22- fixing hole; 3- fixing column; 31- support portion; 33- buckle groove; 34- buckle; 4- first rotating part; 41- first fixing ring; 42- fixing member; 43- rotation column; 44- rotation slot; 45- opening; 5- second rotating part; 51- housing; 52- upper fixing ring; 53- lower fixing ring; 54- bearing unit; 55- buckle position; 56- revolving slot; 57- circular support convex edge; 6- connection column; 7- third rotating part; 71- connection ring; 72- bearing component; 8- support base; 81- support foot; 82- connection rod; 9- pin hole.

### DESCRIPTION OF EMBODIMENTS

The present disclosure will be further described based on the accompanying drawings and specific embodiments.

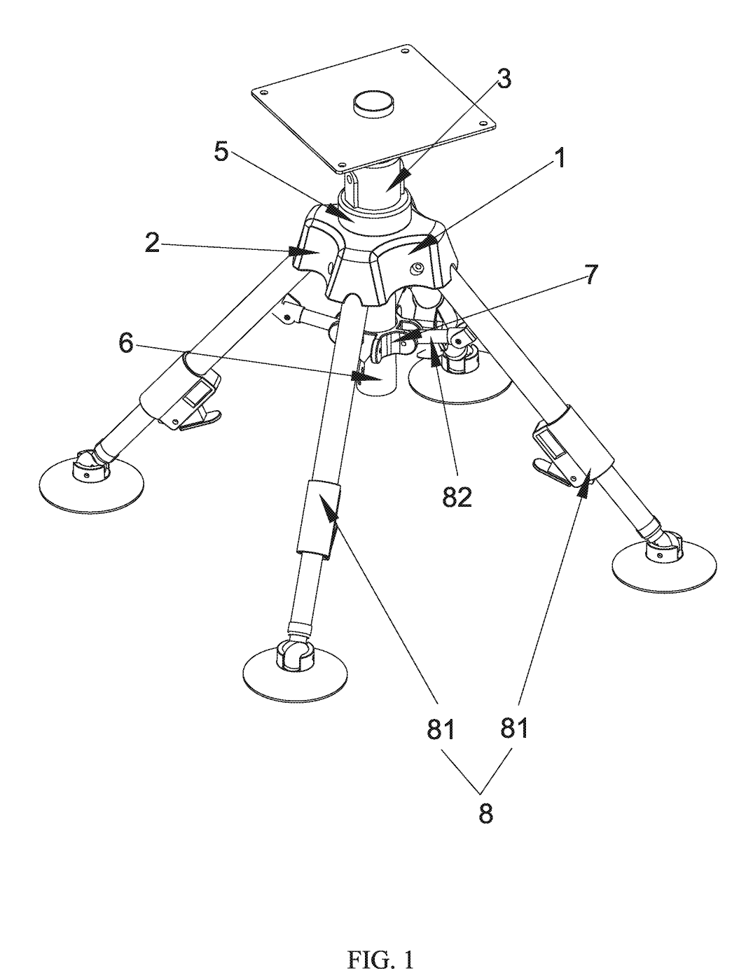

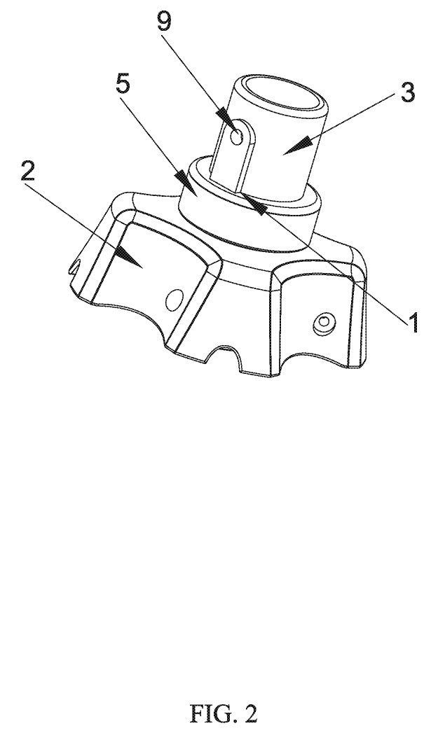

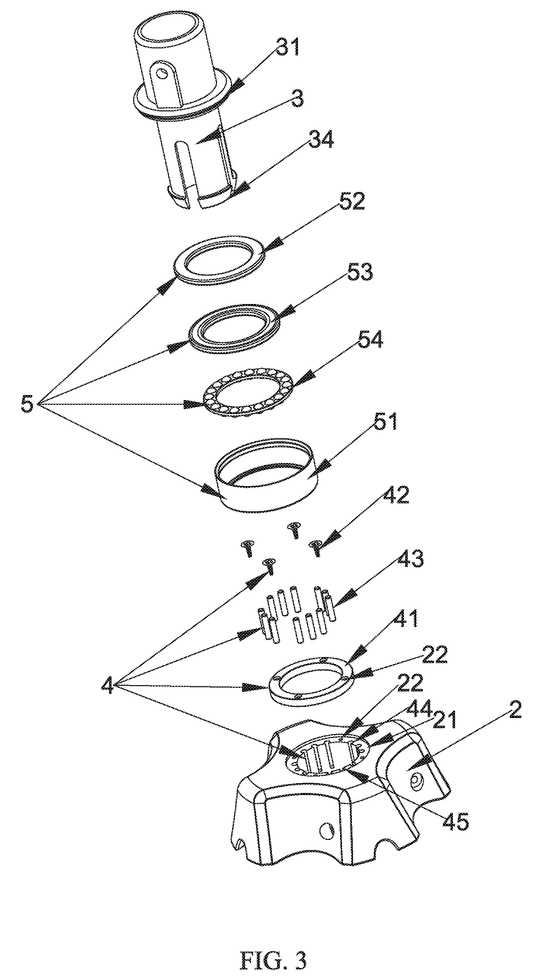

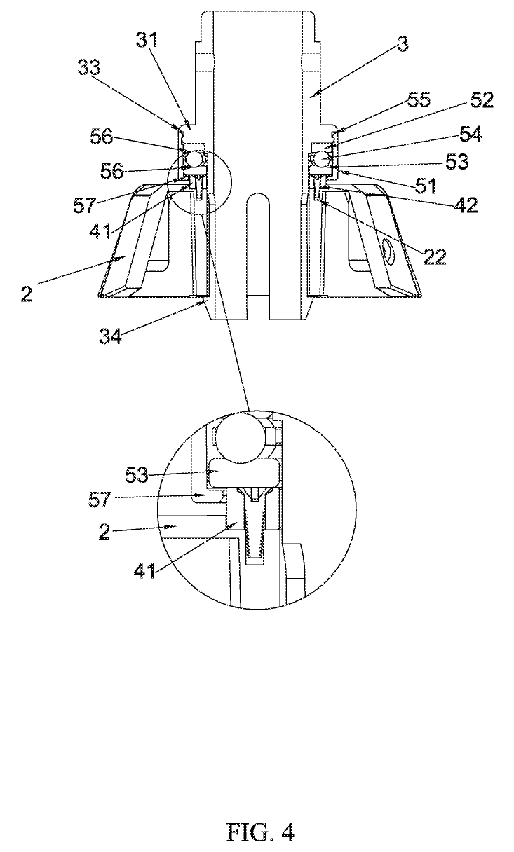

As shown in FIGS. 1 to 4, a core of a low-noise swivel chair provided by the present disclosure lies in an innovative structural design of a seat rotation unit 1. The seat rotation unit 1 includes a fixing base 2 for connecting with a support base 8, and a fixing column 3 for connecting with a seat (not shown in the figure).

The support base 8 includes four support feet 81 that are hinged to the fixing base 2. Upper ends of the support feet 81 are connected to the fixing base 2 through a rotating shaft, and lower ends of the support feet 81 are supported on ground. The four support feet 81 are each connected to a connection ring 71 through a connection rod 82, and two ends of the connection rod 82 are hinged to the support feet 81 and the connection ring 71, respectively.

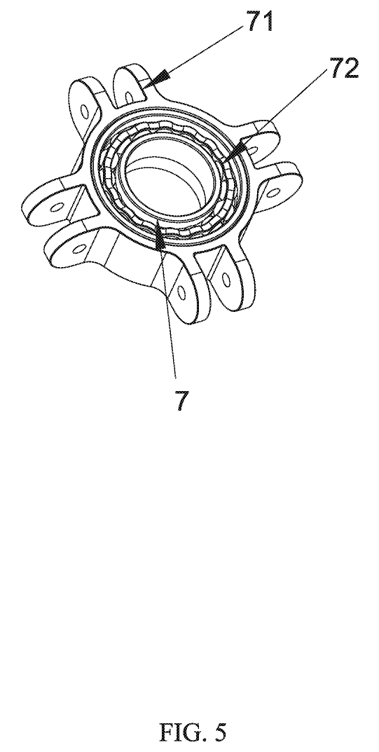

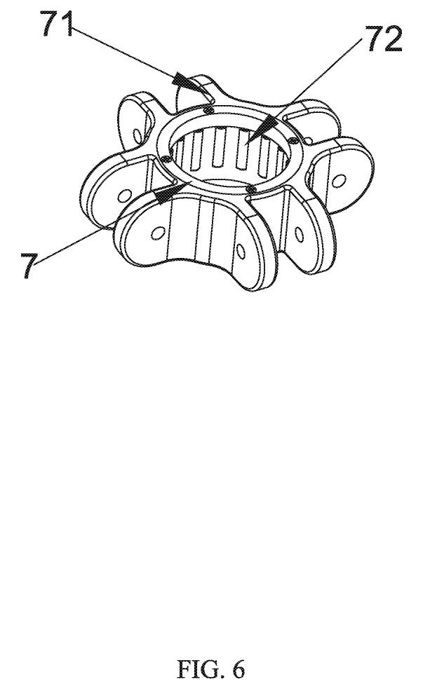

As shown in FIGS. 1, 5, and 6, the fixing column 3 is a hollow structure with a connection column 6 penetrating inside. The connection column 6 is fixedly connected to the fixing column 3, and its upper end is used for installing the seat. Both the connection column 6 and the fixing column 3 are provided with pin holes 9 that are radially penetrating, the pin holes 9 of the connection column 6 and the fixing column 3 are inserted simultaneously through pins (not shown in the figure) to complete a fixed connection between the connection column 6 and the fixing column 3. When a user sits on the seat and rotates, the connection column 6 will drive the fixing column 3 to rotate together.

A lower end of the connection column 6 passes downwards through the connection ring 71, so that when the support feet 81 are folded inward or unfolded outward for use, the connection ring 71 can adaptively move along an axial direction of the connection column 6. A rotational connection between the connection column 6 and the connection ring 71 is achieved through a third rotating part 7, and the third rotating part 7 is an existing bearing component 72, such as a ball bearing or a cylindrical roller bearing.

As shown in FIGS. 1 to 4, the fixing base 2 is a hollow structure with an axial through hole at its center, and the fixing column 3 passes through the through hole at the center of the fixing base 2 and is rotatably connected to the fixing base 2 through a rotating component. The rotating component includes a first rotating part 4 and a second rotating part 5, which are respectively used to withstand radial and axial forces.

The first rotating part 4 is provided between an inner wall of the fixing base 2 and an outer wall of the fixing column 3, mainly used to withstand a radial force of the fixing column 3 and convert a sliding friction between the fixing column 3 and the fixing base 2 into a rolling friction.

In an implementation mode, the first rotating part 4 includes a plurality of rotation slots 44, a rotation column 43, and a first fixing ring 41.

The rotation slots 44 are uniformly spaced in a circular shape on the inner wall of the fixing base 2. Each of the rotation slots 44 is radially inwardly provided with an opening 45, and axially extends upward through a top of the fixing base 2.

Each of the rotation slots 44 accommodates a freely rotatable rotation column 43. A part of the rotation column 43 radially facing an axis and protruding from the opening 45 contacts with the outer wall of the fixing column 3.

The first fixing ring 41 is fixed to the top of the fixing base 2 by a fixing member 42 (such as a screw). In an implementation mode, the top of the fixing base 2 is provided with a fixing groove 21 with an upward opening, and a lower end of the first fixing ring 41 is embedded in the fixing groove 21. The first fixing ring 41 is provided with a fixing hole 22 corresponding to a bottom wall of the fixing groove 21, and the fixing member 42 passes through the fixing hole 22 to lock the first fixing ring 41. A main function of the first fixing ring 41 is to axially limit the rotation column 43 and prevent it from falling out of the rotation slots 44. At the same time, an upper end surface of the first fixing ring 41 also serves as a support plane.

When the fixing column 3 is inserted into the fixing base 2, its outer wall contacts with the protruding rotation column 43. When the fixing column 3 rotates, the rotation column 43 is driven to roll in its rotation slots 44, thereby achieving low noise and low wear rotation.

As shown in FIGS. 1 to 4, the second rotating part 5 is sleeved on an outer circumference of the fixing column 3 and provided above the fixing base 2, mainly used to withstand an axial force of the fixing column 3 (i.e. the user’s weight).

In an implementation mode, the second rotating part 5 includes a bearing unit 54, an upper fixing ring 52, and a lower fixing ring 53 as core components for achieving rolling friction. The bearing unit 54 is provided between the upper fixing ring 52 and the lower fixing ring 53. Rotation slots 56 are provided at a position where the upper fixing ring 52 and the lower fixing ring 53 are abutted against the bearing unit 54 to better accommodate and guide the bearing.

The second rotating part 5 is further provided with a housing 51, and the housing 51 is sleeved around outer circumferences of the upper fixing ring 52, the lower fixing ring 53, and the bearing unit 54, thereby forming a protective housing. A lower end of the housing 51 has a circular support convex edge 57 extending inward, and the circular support convex edge 57 supports the lower fixing ring 53 from the bottom.

There is a support portion 31 extending radially outward on the fixing column 3. After assembly, the support portion 31 is supported on an upper surface of the upper fixing ring 52; a lower end of the entire second rotating part 5 (i.e. a lower surface of the lower fixing ring 53) is supported on the upper end surface of the first fixing ring 41.

Besides that, in order to achieve a fixation of the housing 51, a buckle groove 33 is provided on an outer wall of the support portion 31, and a corresponding buckle position 55 is provided on the housing 51. The housing 51 is buckled to the support portion 31 of the fixing column 3 through a cooperation of the buckle groove 33 and the buckle position 55.

An annular gap is provided between the circular support convex edge 57 at the lower end of the housing 51 and a column body of the fixing column 3. An upper end of the first fixing ring 41 of the first rotating part 4 actually constitutes an upper end of the first rotating part 4. The first fixing ring 41 extends upward and directly enters a chamber formed by the housing 51 through the above-mentioned annular gap, and supports the lower fixing ring 53 of the second rotating part 5 from the bottom. This design lies in that it elevates the entire housing 51 and its internal second rotating part 5, ensuring that a lower edge of the housing 51 does not contact with an upper surface of the fixing base 2 and is in a “suspended” state. This completely eliminates a possible friction noise between the two.

A bottom of the fixing column 3 is provided with a buckle 34 that is radially outward extending. When assembling, the fixing column 3 is inserted into the fixing base 2, and the buckle 34 at a bottom passes through a lower end hole of the fixing base 2 and uses the elasticity of the material to recover deformation and is clamped on an edge of the hole. This effectively prevents the fixing column 3 from slipping upwards, thereby achieving a reliable axial positioning.

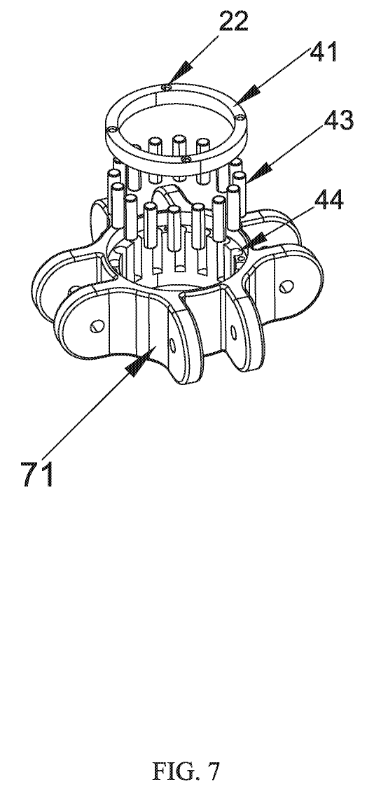

As shown in FIG. 7, the bearing component of the third rotating part 7 can also have a same structure as the first rotating part 4, that is, rotation slots are provided on an inner wall of the connection ring 71 and the rotation column is provided in the rotation slots, and finally an axial limit of the rotation column is achieved through the first fixing ring.

Description of working principle: when the user sits on the seat, the axial force generated by his weight is transmitted to the second rotating part 5 through the connection column 6 and the support portion 31 of the fixing column 3, and finally transmitted to the fixing base 2 through the first fixing ring 41. When the user rotates the seat, the fixing column 3 and the connection column 6 are rotated together. At this time, the radial force is withstood by the rotation column 43 of the first rotating part 4 in a rolling form. A friction of the axial rotation is withstood by the bearing unit 54 of the second rotating part 5 in the rolling form. The rotational friction between the connection ring 71 and the connection column 6 is withstood by the bearing component 72 of the third rotating part 7. Through a synergistic effect of these three rotating parts, low-noise operation of the swivel chair has been achieved in all directions and under all working conditions.

What is claimed is:

1. A low-noise swivel chair, comprising: a seat rotation unit, and the seat rotation unit comprises a fixing base configured to connect with a support base and a fixing column configured to connect with a seat,
wherein the fixing column passes through the fixing base in an axial direction and is rotatably connected to the fixing base through a rotating component,
wherein the rotating component comprises:
a first rotating part, which is provided between an inner wall of the fixing base and an outer wall of the fixing column and is configured to withstand a radial force of the fixing column;
a second rotating part, which is sleeved on an outer circumference of the fixing column and provided above the fixing base; the fixing column is provided with a support portion that is radially outward extending, and the support portion is supported on the second rotating part, a lower end of the second rotating part is supported on the fixing base to withstand an axial force of the fixing column.

2. The low-noise swivel chair according to claim 1, wherein an outer side of the second rotating part is provided with a housing, an upper end of the housing is fixedly connected to the support portion, a chamber configured to accommodate the second rotating part is provided between the housing and the fixing column, and the housing is not in contact with the fixing base below;
an annular gap is provided between a lower end of the housing and the fixing column, and an upper end of the first rotating part extends upward and extends into the chamber through the annular gap, thereby providing an axial support for the second rotating part.

3. The low-noise swivel chair according to claim 2, wherein an outer wall of the support portion is provided with a buckle groove that has an outward opening; the housing is provided with a corresponding buckle position; the housing is connected to the fixing column through a cooperation between the buckle groove and the buckle position.

4. The low-noise swivel chair according to claim 2, wherein the first rotating part comprises:
a plurality of rotation slots, which are uniformly spaced in a circular shape on the inner wall of the fixing base, radial inner sides of the rotation slots have openings, and the rotation slots axially and upward penetrate through a top of the fixing base;
a rotation column, which is rotatably accommodated in the rotation slots, and a portion of the rotation column that is radially facing an axis protrudes from the openings;
a first fixing ring, which is fixed at the top of the fixing base and configured for axial limiting the rotation column, and an upper end surface of the first fixing ring is in contact with the lower end of the second rotating part.

5. The low-noise swivel chair according to claim 4, wherein the top of the fixing base is provided with a fixing groove with an upward opening, and a lower end of the first fixing ring is embedded in the fixing groove;
the first fixing ring is provided with a fixing hole corresponding to a bottom wall of the fixing groove, and a fixing member is inserted into the fixing hole to fix the first fixing ring to the fixing base.

6. The low-noise swivel chair according to claim 2, wherein the second rotating part comprises an upper fixing ring, a lower fixing ring, and a bearing unit;
the upper fixing ring, the lower fixing ring, and the bearing unit are sleeved on the outer circumference of the fixing column, and the bearing unit is provided between the upper fixing ring and the lower fixing ring;
the support portion is supported on an upper surface of the upper fixing ring;
the housing is sleeved on outer circumferences of the upper fixing ring, the lower fixing ring, and the bearing unit,
the lower end of the housing has a circular support convex edge, and the circular support convex edge is supported on a lower surface of the lower fixing ring.

7. The low-noise swivel chair according to claim 6, wherein the circular support convex edge is not in contact with the fixing column, and the annular gap is formed between the circular support convex edge and the fixing column.

8. The low-noise swivel chair according to claim 6, wherein a revolving slot is provided at a position where the upper fixing ring and lower fixing ring that are abutted against the bearing unit.

9. The low-noise swivel chair according to claim 1, wherein a bottom of the fixing column is provided with a buckle that is radially outward extending, and after the fixing column passing through the fixing base and completing assembly, the buckle is engaged with an edge of a lower end hole of the fixing base to axially limit the fixing column.

10. The low-noise swivel chair according to claim 1, wherein the fixing column is a hollow structure, and a connection column is provided inside,
the connection column is fixedly connected to the fixing column;
an upper end of the connection column is configured to fixedly connect with the seat;
the support base comprises a plurality of support feet, ends of the support feet are rotatably connected to the fixing base, and other ends are supported on ground;
a connection ring that is configured to slide along an axial direction of the connection column is connected between each of the support feet through a connection rod;
a lower end of the connection column passes through the connection ring and is rotatably connected to the connection ring.

11. The low-noise swivel chair according to claim 10, wherein the connection ring and the connection column are rotatably connected through a third rotating part, and the third rotating part is a bearing component.
